(19) United States
(12) Patent Application Publication
(10) Pub. No.: US 2004/0019691 A1
(43) Pub. Date: Jan. 29, 2004

(54) Method and system for set-top box service and support

(76) Inventors: Michael Daymond, Schomberg (CA); Nelson Patricio Oliveira, Toronto (CA)

Correspondence Address: Martin Korn, Locke Liddell & Sapp LLP, 2200 Ross Ave., Ste .2200, Dallas, TX, 75201, US

(21) Appl. No.: 10/202,908

(22) Filed: Jul. 26, 2002

(51) Int. Cl. G06F 15/16

(52) U.S. Cl. 709/231

(57) ABSTRACT

The present invention relates a method and system for television set-top box (STB) service and support. Typical STBs provide little feedback to the user when there is an error or a failure, and generally only do so when the user attempts to perform a task. The system of the invention employs periodic testing of various devices and applications, so that the user is generally of failures in advance. As well, the testing is performed at different levels in the system, so that the user can be provided with troubleshooting information tailored to the particulars of the failure. Thus, when there is a failure, the user is provided with focussed instructions on how to address it. If the user ultimately has to contact a help desk, this feedback information can be passed to the help desk, which greatly reduces the burden on the help desk.

The present invention relates generally to convergent multimedia systems, and more specifically, to a method and system for television set-top box (STB) service and support.

### BACKGROUND OF THE INVENTION

Over the last two decades, telecommunication services have seen tremendous change. The familiar analogue telephones, radios, televisions and recording devices are being, or have already been, replaced with higher quality, more powerful and more flexible digital devices.

Television broadcasting, for example, traditionally offered no more than thirty or forty channels, available on a local basis using short-range wireless FM (frequency modulated) transmissions or analogue cable networks. Digital satellite transmissions now offer hundreds of television channels and the broad footprint of the satellite transmissions mean that these signals can be received across vast geographical areas. High definition television (HDTV) standards are also being established and widely accepted, offering much higher quality, which is almost a necessity for the wide-screen televisions common today. As well, pay-per-view, direct-to-home and video-on-demand services now allow Users to have access to more valuable viewing products, and on a more flexible scheduling basis.

The last decade has also seen the explosive growth of data communication networks such as the Internet, Wide Area Networks (WANs) and Local Area Networks (LANs), offering tremendously efficient means of organizing and distributing computerized data. These efficiencies have resulted in widespread use for both business and personal applications.

The Internet is an excellent medium for multimedia applications because of the rich formatting, including for example, sound, animation and personal interaction with the End User. As well, access to the Internet is almost pervasive in developed countries. As a result, the Internet has become a common medium for operating online auctions, academic and public forums, retail shopping, remote computing, Internet radio, distributing publications such as newspapers and magazines, and performing electronic mail (email) transactions.

The personal computers (PCs) which Users generally employ to access the Internet, have also grown in power over the last decade. They are now able to decompress and play high fidelity sound and high quality video at real time speeds. As well, many PCs are able to record this information flawlessly on optical storage media such as CD Roms and DVDs.

While these telecommunication systems are already complex, there is a market for new services such as voice-over-IP (using the Internet as a voice telephone network), video telephony, Internet games, remote collaborative work and telemedicine.

As well, there is pressure to support all of the services described above on single, “convergent” devices which makes the software and hardware development and support tasks even more complex. One such convergent device which is showing great promise is the set-top box (STB). This device acts as an interface between a television or other signal acquisition device, and various telecommunication media such as telephone lines, television cable networks and xDSL (digital subscriber line) facilities.

Interconnectivity to other media or mediums may interface over a local area network (LAN).

Unfortunately, the Internet is not well suited to real-time global transmission or communication. The whole premise of the Internet is to interconnect a vast and disparate collection of computers, servers, routers, computer networks and public telecommunication networks, allowing two parties to communicate via whatever entities happen to be interconnected at any particular time.

Unless a dedicated pipeline is reserved (which consumes enormous resources), the Internet offers no guarantees as to how quickly or uniformly data packets will arrive, or even the order in which the data packets will arrive. Each data packet is numbered so that the packages for a larger message can be reassembled in the correct order, but to maintain real-time operation, late packets often must be discarded. Thus, the quality that real-time Internet transmissions offer can never be guaranteed.

While the speed of Internet access is improving, as is the speed of the Internet backbone, it still must increase by orders of magnitude in order to have the bandwidth necessary to offer effective high quality video transmissions in real time. Digital subscriber line access (DSL), for example, can offer “last-mile” communication rates on the order of 800 kbps (kilobits per second) but communication can never be effected any faster than the slowest device interconnecting the two end points in the communication. Improving the speed of the “last-mile” may improve communication rates between some points, some of the time, but does not address all of the bottlenecks in the system.

Another problem is that the market for convergent devices is very price sensitive. Thus, many convergent devices are sold with limited functionality in an effort to keep costs down. For example:

1. some convergent devices use a single communication channel to provide all content and data communication including web browsing, email, and real time video. This is simply an inefficient use of resources as the range of services is too diverse; real time video often demanding 100 times the bandwidth or more than the email or web browsing services;

2. most set-top boxes only have the hardware and operating system to support one service at a time. To toggle between a television program and an email service, for example, requires one to close the television program window altogether and launch a new software application to open the email window. The closing and launching of applications is a painfully slow process and does not allow real-time interaction between the various services; and

3. in an effort to keep costs down, features that are not essential are rarely included in a set-top box. Thus, typical set-top boxes include no internal diagnostics and little or no User feedback in the event of errors, failures or other problems.

Finally, Users of television and telephone devices are used to having very high levels of service which simply do not exist on today's computer-based and Internet-based communication systems.

System failures are particularly frustrating to the User when they are unexpected. For example, a User may prepare an email message only to find that his Internet connection has been lost.

If the above problems could be overcome, convergent devices could be offered which truly support comprehensive and reliable multimedia services. As well, such a system could be adopted to many electronic devices, and would not simply be limited to set-top boxes.

There is therefore a need for a reliable, convergent, multi-media system, provided with consideration for the problems outlined above.

### SUMMARY OF THE INVENTION

It is therefore an object of the invention to provide a method and system which obviates or mitigates at least one of the disadvantages described above.

One aspect of the invention is broadly defined as a method of operating a convergent multimedia device comprising the steps of: performing connectivity testing between the convergent multimedia device and interconnected devices; and

responding to the failure of one or more of the connections by presenting an announcement on a display screen.

Another aspect of the invention is defined as a convergent multimedia system comprising: an Internet Service Provider; a Home Network; a convergent multimedia device on the Home Network; an Internet Gateway connected to the Home Network;

and a hard-wired, communication network for connecting the Internet Gateway to the Internet Service Provider; the convergent multimedia device having a multitasking operating system, being connected to a display screen and an audio output device, and being operable to perform the steps of: checking connectivity between the convergent multimedia device and the Internet Gateway; checking connectivity between the convergent multimedia device and the Internet Service Provider;

checking connectivity between the convergent multimedia device and the Home Network; and responding to the failure of one or more of the connections by presenting an announcement on the display screen or the audio output device.

### BRIEF DESCRIPTION OF THE DRAWINGS

These and other features of the invention will become more apparent from the following description in which reference is made to the appended drawings in which:

FIG. 1 presents a block diagram of an exemplary convergent communication system in a broad embodiment of the invention;

FIG. 2 presents a block diagram of an exemplary convergent device in a broad embodiment of the invention;

FIGS. 3A and 3B present a flow chart of a method of operation for a convergent device in a broad embodiment of the invention;

FIG. 4 presents a block diagram of a convergent communication system in a preferred embodiment of the invention;

FIGS. 5A through 5C present state diagrams of a method of operation for a set top box in a preferred embodiment of the invention; and

FIGS. 6A through 6D present screen captures of dialogue boxes to be displayed to the User, in a preferred embodiment of the invention.

### DETAILED DESCRIPTION OF PREFERRED EMBODIMENTS OF THE INVENTION

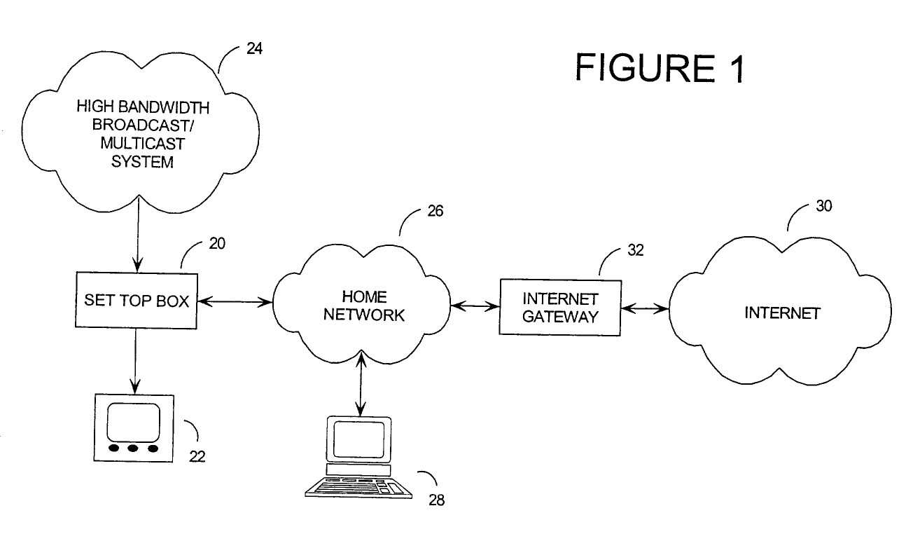

A system and methodology which addresses the objects outlined above, is presented in FIGS. 1 through 3.

To begin with, FIG. 1 lays out a block diagram of an exemplary system for implementing the invention. Most convergent systems do not offer comprehensive multimedia services because they lack the necessary infrastructure. A truly comprehensive system requires the User interface (typically a video display/audio device such as a television or multimedia-enabled personal computer) to have interconnectivity with:

1. a download-only high-bandwidth media channel for receiving audio/video broadcasts or multi-cast data;

2. a local area network (LAN) so that access can be made to a local computer or similar device; and

3. access to the Internet via a bi-directional communication channel.

In FIG. 1 a block diagram of such a system is shown. In this example, the User accesses his multimedia content via a set-top box 20 and television 22. The set-top box 20 receives high-bandwidth data from an external source of some kind 24. This high-bandwidth source 24 could distribute content using broadcast, multicast, narrow cast, unicast or other techniques, and access customers using various high-bandwidth communication media (including satellite, cable, HFC and xDSL communications). The only restriction on this high-bandwidth source 24 is that it must be able to offer connection-oriented, high-bandwidth services. Many systems are available for doing this, including the following:

1. land based wireless systems such as point-to-point transmissions;

2. Earth orbiting communication satellites such as geostationary or low Earth orbit (LEO) satellites, geosynchronous and middle Earth orbit (MEO) systems. These systems all have a high initial capital cost, but they can broadcast over such a broad geographic area (referred to as the “footprint”), that they can generate sufficient revenues to offset their costs;

3. digital cable television networks; and

4. VDSL (Very High Speed Digital Subscriber Line).

Any kind of Home Network 26 or LAN could be employed, including an Ethernet or the like. This network is necessary to interface with personal computers 28, and other Internet or LAN appliances such as printers or Internet fax machines that the User may have.

In the preferred embodiment described hereinafter, access to the Internet 30 is shown via the Home Network 26, using an Internet Gateway 32, but it could be accessed directly by the set-top box 20. There are many bidirectional techniques for accessing the Internet 30, including for example: dial-up modems using telephone lines, DSL (digital subscriber line) over telephone lines, television cable modems, wireless local loops, point-to-point wireless and cellular telephone networks.

A convergent device which provides the necessary functionality could be embodied in many different forms using many different architectures. The embodiments of the invention are generally described herein with respect to a television set-top box, but it is understood that the invention could be implemented on other devices. For example, the functionality of the invention could be made integral to the television, a Personal Computer (PC) or similar device.

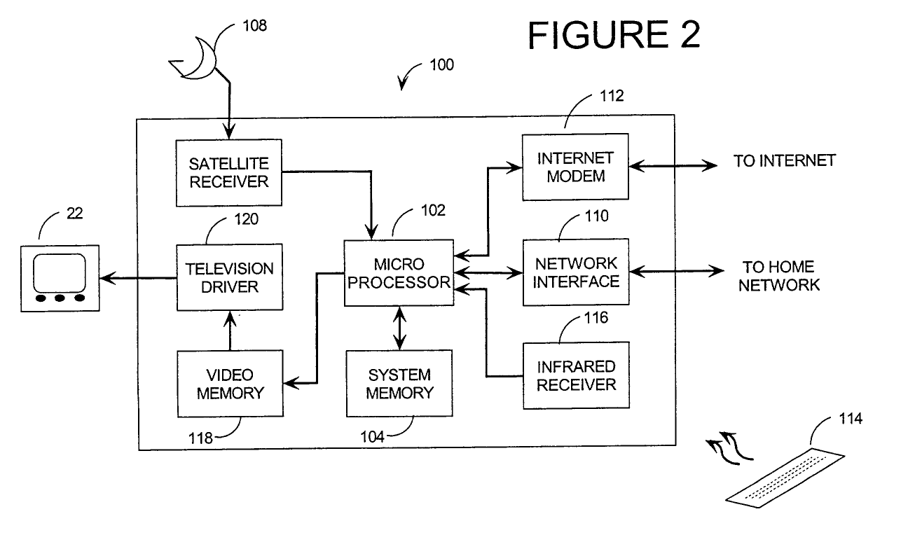

An exemplary television set-top box that is compatible with the system of FIG. 1, is presented as a block diagram in FIG. 2. At the heart of the set-top box 100 lies a microprocessor 102 which controls all of the data processing input/output and software applications. While a generic microprocessor such as a Pentium III could be used, dedicated microprocessors, digital signal processors (DSPs), micro-controllers or application specific integrated circuits (ASICs) could also be used.

Software for controlling the microprocessor 102, software applications and data content are stored on the system memory 104. The system memory 104 could be comprised of read only memory (ROM), random access memory (RAM) or various high density storage media such as magnetic disk drives (hard disks), optical drives such as CD ROMs or other bulk storage media as known in the art. Typically, the system memory 104 will include a combination of these volatile and non-volatile memories, to store an operating system, web browsers, email software and other software applications.

The set-top box (STB) 100 also includes a satellite receiver 106 for receiving video data via an external satellite antenna or dish 108. Note that such a device will generally only receive satellite data and not have the functionality to transmit data.

The STB 100 may also communicate with a home local network via a network interface card 110. This is a bi-directional channel as data may be received or transmitted to the home network. Ethernet, USB and RS-232 cards are common examples of such a network interface card 110.

The STB 100 may also include an internal modem 112 for communicating with the Internet 30. This modem 112 may be used to contact an Internet Service Provider to obtain Internet access over telephone lines, a cable television network or wireless. Alternatively, the interconnection to the Internet 30 may be made via the local area network in which case the set-top box 100 itself may not include an internal modem 112.

The STB 100 also requires an interface with the User. In this case the interface is provided by an external alpha numeric keyboard 114 which communicates with the STB 100 using a wireless infrared (IR) connection and an infrared pickup 116 in the STB 100. Alternatively, a hard wire connection may be used or a different wireless technique such as a radio frequency connection (RF). Keyboards 114 for STB 100 often have dedicated keys (such as volume adjustment, or keys for launching specific applications), but may also be replaced with less sophisticated remote control hand held devices.

Output video and audio data is stored in the video memory 118 of the STB 100 and is processed as required by the television driver 120 before being transmitted to the television 22.

The interconnection between the set-top box 100 and the television 22 may be effected in a number of manners as known in the art, for example:

1. the use of line level audio and video connections;

2. the use of separate luminance and chrominance signals, for example, in an SVHS format; or

3. by modulating the audio and video signals onto a carrier channel such as channel 3 or 4. Such an arrangement may be necessary for television sets 22 not having separate audio and video inputs.

It will be appreciated by those skilled in the art that the block diagram of FIG. 2 is greatly simplified. It is common, for example, for set-top boxes to have the functionality to super-impose alphanumeric characters, other symbols and bitmap graphics over the video images stored in the video memory 118. As well, the set-top boxes may have various tuners, modulators/demodulators, decoders/decrypters, demultiplexers, filters, and cable connections. However, such details are known in the art and will not be addressed herein.

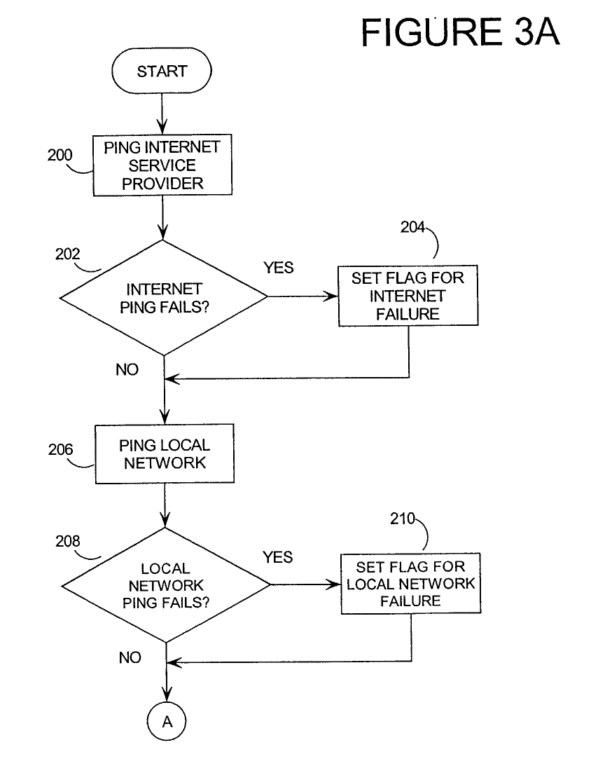

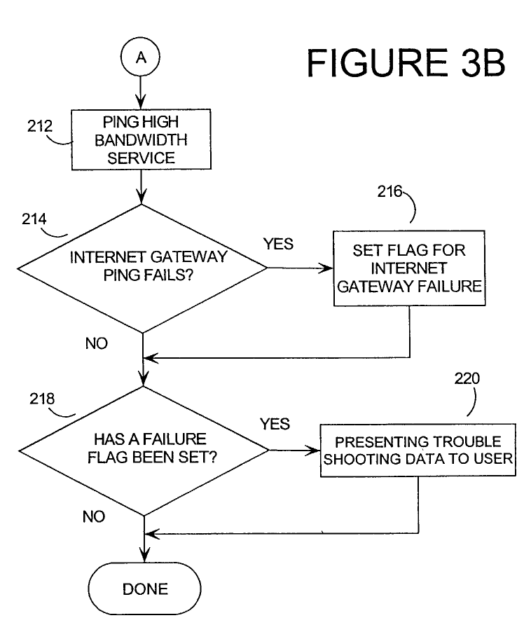

The method of the invention is now described with respect to the flow charts of FIGS. 3A and 3B, and against the backdrops of FIGS. 1 and 2. In short, the method is to check connectivity and operability at three different levels, on a periodic basis: the Internet Service Provider, the Internet Gateway, and the home network connection. As noted in the background, there are many instances where the User may be working in one domain, with the expectation that another domain will be available, only to find out that it is not. The invention resolves this by checking the connectivity of each system periodically and advising the User of any problems.

One way of implementing such a process is presented in the flow chart of FIGS. 3A and 3B. Clearly, there are unlimited variations that could be made to this routine.

The process begins at step 200 where the set-top box 100 “pings” the Internet service provider. A “ping” is a software utility used to determine whether a specific IP address is accessible. It works by sending a packet to the specified address and waiting for a reply. Alternatively, a “gethost” command could be executed, which causes a packet to be sent to the DNS (domain name server), asking it to resolve an IP address to a server. If the DNS responds, then obviously the Internet connection is operating.

It will be clear from the description which follows, that the purpose of issuing such “ping” and “gethost” commands is to obtain details regarding errors and failures. The more information that can be obtained in this respect, the more effective the troubleshooting process will be. Therefore, one could even issue “gethost” commands down to the application layer, where the Internet Service Provider uses different servers to support different applications (an email server, for example). Thus, the manner in which this step is effected will depend on the architecture of the system, and the level of detail that is desirable.

The routine then waits at step 202 for a certain period of time, and if no reply is received, the ping is considered to have failed. On failure, an “Internet failure” flag is set at step 204.

Regardless of whether the Internet ping is successful, control then passes to step 206 where a ping is issued to the home network. Again, a certain time period can be allowed for a response at step 208 and on failure, a “home network failure” flag is set at step 210.

Finally, the same process is repeated at steps 212-216 for checking the connectivity of the Internet Gateway. Note that the ping at step 212 will be different from that of step 200 above, as typically the Internet Gateway will not be associated with an IP address.

Then, like the Internet and home network checks above, the routine sets an “Internet Gateway failure” flag at step 216, if this ping fails at step 214.

Having completed the set of connectivity checks, at step 218, the system now checks to see whether any failure flags were set, and if so, presents the User with troubleshooting information at step 220. If no failure flags were set, the routine simply ends.

Step 220 is an important step because many systems simply present a “connectivity failure”, “system error”, or “service not available” message to the User. The User is then left to sift through an operating manual, or contact a telephone-based service and support person (the “help desk”). Help desks are expensive and are placed at a great disadvantage because they do not have access to the system that has the problem. The set-top box 20 itself, however, is in position to run other diagnostics, or at least take many factors into account, before deciding how to advise the User.

The method of the flow charts of FIGS. 3A and 3B, can be repeated periodically under the supervision of a hardware or software timer, or be hard coded into the operation of the STB 20. In the preferred embodiment of the invention, this testing is performed every 5 minutes, simply to keep the burden on the complete system under control. Technically, the system could perform these tests much more often, particularly the local tests (the local burden is insignificant compared to the burden that the real time content presents to the system). However, the remote burden is significant—if a typical community has 8,000 to 10,000 set-top boxes, it would not be practicable to perform the pinging more often than every five minutes or so.

As noted in the background, cost is very important in the convergent service market, but most companies focus on the STB 20 itself, rather than looking at the whole system. While the STB 20 of the invention may cost more than other set-top boxes, the system as a whole, offers improved service at a lower cost—because the new service layer is automated, it will decrease the “help-desk” overhead required, so the overall cost of the system will go down. To emulate the service representative (“help-desk”) layer, this new layer has to provide instructional and/or troubleshooting data.

The invention of FIGS. 1 through 3B addresses many of the problems in the art. It provides a true convergent platform by supporting both Internet connectivity and high-bandwidth connectivity, which is necessary for real-time transmission of audio/video programming. As well, by monitoring the connectivity of the various communication channels, Users are surprised by communication difficulties far less often. This improves the reliability of the system and improves the User's experience with it. Other advantages of the invention are identified with respect to particular embodiments of the invention described hereinafter.

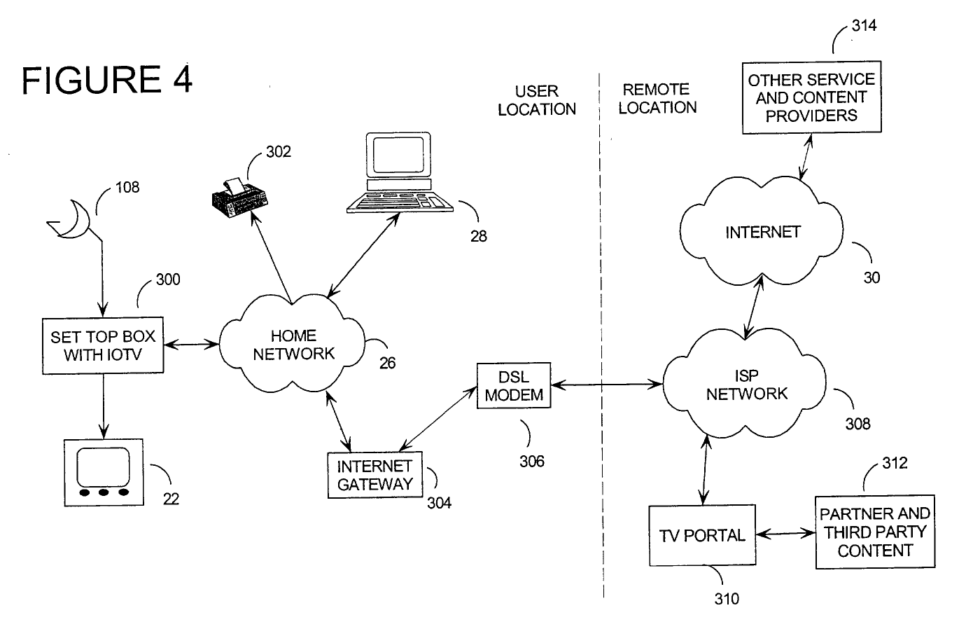

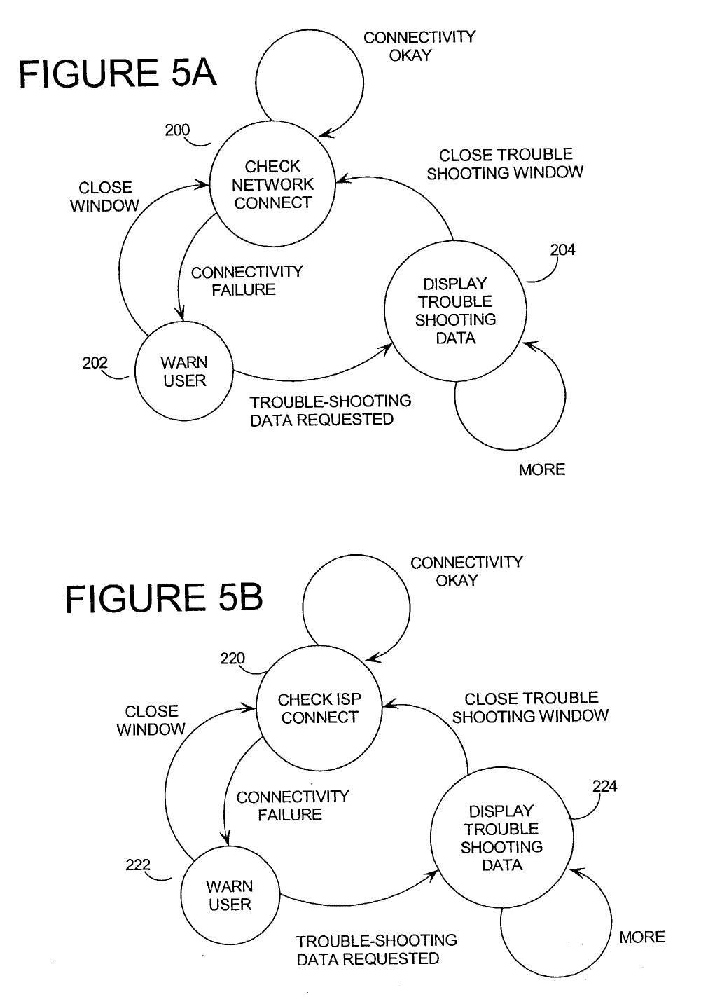

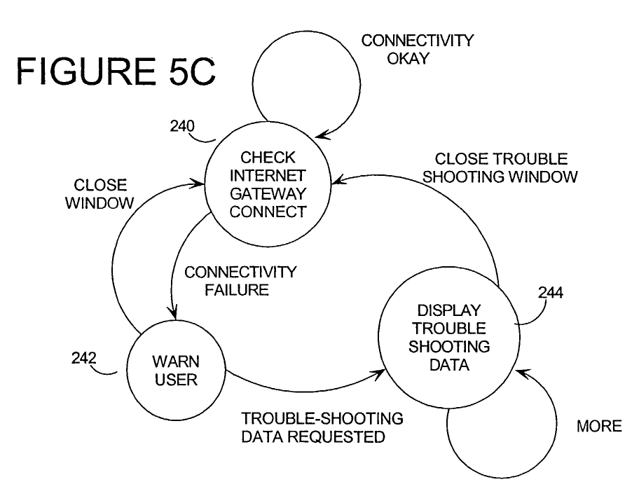

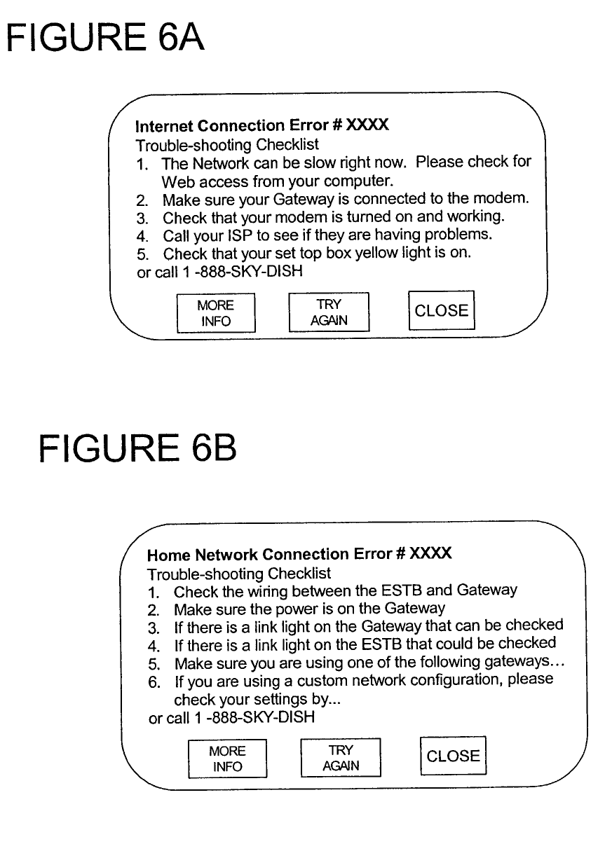

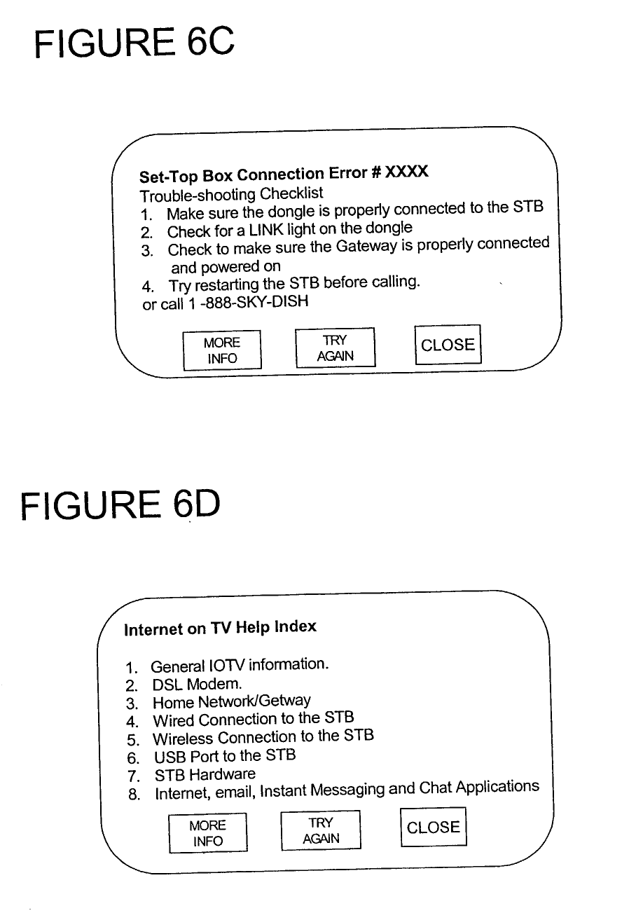

The preferred embodiment of the invention is presented by means of the block diagram of FIG. 4, the flow charts of FIGS. 5A through 5C, and the dialogue boxes that will be presented on the User's screen, per FIGS. 6A through 6D.

To begin with, the physical arrangement of the preferred embodiment is much the same as those presented above with respect to FIGS. 1 and 2 above.

There are, however, some additional details which should be considered. Referring to FIG. 4, the high bandwidth data channel is preferably provisioned using a geostationary satellite, so the User must have a receiving dish 108, and the set-top box (STB) 300 provisioned accordingly. This is the least complex of the satellite transmission techniques currently available, and is generally the least expensive and most reliable for this application. Many digital television broadcast systems use this technique, including, for example, Bell Express Vu.

The STB 300 itself, has a number of important features including the following:

1. Operating System

The operating system for the STB 300 is preferably a multi-processing operating system such as a Windows or Linux based system. This allows the connectivity checking to be performed while other operations are also being performed.

It also allows more than one application to be active at the same time. Thus, Users can toggle back and forth between applications, or even have more than one application open on the screen at the same time (say, for example, having a television program playing, and using the Web browser to view a television schedule on a portion of the screen at the same time). Of the operating systems currently available, the public domain operating systems such as Linux, are preferred over the proprietary offerings. As noted above, the STB market is very cost sensitive, so this selection can result in reduced costs and a very significant market advantage. Linux-based operating systems generally require the addition of a windows manager, but many suitable windows managers are also available;

2. Internet On Television (IOTV) Capability

The IOTV package is a bundle of 3 popular Internet applications: Web Browsing, email and Instant Messaging (IM). Other applications could also be implemented, such as Chat.

Users can enjoy these features using the full television screen or share the screen with another application (due to the use of the multiprocessing operating system). It is straightforward to offer these IOTV services with standard features such as:

a. the Web browser supporting 128 bit SSL (secure sockets layer) to allow for on-line banking and electronic commerce transactions;

b. the email being operable to access Bell Sympatico web email service, or any POP3 or IMAP service;

c. the IM client allowing popular IM features, and interoperating with Sympatico-Lycos' planned IM service as well as the major IM services, including ICQ, AOL Messenger, and MS Messenger; and

d. notification being supported for IM.

The IOTV service will allow for up to 6 User profiles, so that User ID and passwords, address books, bookmarks, and notification preferences will be stored and activated, allowing rapid access to services; and

3. Home Network Connectivity

In the preferred embodiment, the STB 300 is supplied with an Ethernet port 30 for connection to the Home Network 26, though a USB (universal services bus) port could also be used. The intent is that the User can purchase a low cost third party Home Network interface device to connect their STB 300 to their Home Network 26 (if necessary). Installation and configuration of the connection to the Home Network 26 and any necessary adapters, can easily be automated using “plug-and-play” techniques known in the art.

Currently popular Home Networks are based on Ethernet, 802.11, HomePNA and Home RF, though almost any network could be used that supports TCP/IP (telecommunication protocol over Internet Protocol—the standard Internet communication framework). The choice of this technology will be up to the customer. A mixture of technologies is possible as well.

In FIG. 4, the Home Network 26 is shown to support a Personal Computer (PC) 28 and a printer 302, though any number of appliances could be supported. The PC 28 could be any platform (IBM-compatible or Macintosh, for example), provided it is compatible with the rest of the network.

The Home Network 26 preferably communicates with the Internet services using a DSL (digital subscriber line) modem 306, which allows high speed communication on the order of 800 mbps. The DSL will generally require an Internet Gateway 304 as an interface to the Home Network 26. Such Internet Gateways 304 typically provide software functionality to allow multiple Internet devices on the Home Network 26 to access the Internet 30, and they also protect the Home Network 26 from external security risk. This also provides a PPPoE (Point-to-Point Protocol over Ethernet) client to support Sympatico Access Manager.

All of these components are found on the User location. The system components that are remote from the User will now be described.

The remote components may vary a great deal, depending on the services being provided and the nature of the network itself. These nature of these components generally do not limit the invention itself.

In the preferred embodiment, the User will access the network of an Internet Service Provider (ISP) using the DSL modem 306, which may communicate over copper wire such as a telephone network, or using a DOCSIS modem over a cable television network. The ISP's network 308 may have many modems, multiplexers, servers, data storage units, computers or other components.

In the preferred embodiment, the ISP will have components to support a television portal (TV portal) 310, which will also have access to partner and third party content 312.

The TV Portal 310 will generally be different from an Internet Portal in at least the following ways:

1. Usability Requirements.

The viewing experience on a television is different than that of a PC. For example, a person is typically sitting much farther away from a television than a PC, resulting in a requirement for larger text fonts, as well as more simple and concise presentation; and

2. Television Context.

Given that all of the TV Portal 310 cannot be reasonably re-purposed for optimal television presentation, the extent and specific content needs to be selected to have the most value in a television context.

Generally, the content which will be support by the TV Portal 310 can be categorized as follows:

1. Re-purposed Portal Content.

Content from the ISP's existing Internet Portal can be re-purposed for the TV Portal 310, rather than generating new content;

2. Highest Usage Sites.

The highest trafficked sites can be re-purposed and cached on the TV Portal 310. The focus will be to port the top 4 or 5 broadband verticals (although high bandwidth streaming video would not be offered);

3. Complementing the TV Viewing Experience.

The content on the TV Portal 310 should complement a television viewing experience. Thus, the TV Portal 310 should allow Users to: look up a phone number for an advertising company, look up the playing time for an advertised movie, or find the value of personal stocks after seeing a business news story;

4. Complement the High-Bandwidth Service Offering.

Similar to item 3 above, the TV Portal 310 should complement the high-bandwidth service offering by providing schedules and additional information regarding the products available;

5. Leverage Partner Content.

The strategy will be to leverage Partner's assets and content as they fit into the TV Portal 310. This could include content from news services, sports services, record and movie producers, and the like; and

6. Revenue Generation.

The TV Portal 310 could be used to generate revenues using electronic commerce techniques known in the art.

In addition, the ISP Network 308, would also have access to the Internet 30, so that content could be imported from other service and content providers 314. These Web pages of these service and content providers 314 may be tailored for television viewing, but many will not. As well, some of these service and content providers 314 may have peering connections with the ISP's network 308, but in general, traffic will transit the Internet 30.

As noted above, it is preferable that the operating system of the invention be a multi-processing operating system. Thus, the connectivity testing of the invention can be effected by launching separate threads for each connectivity test. In this way, the connections can be tested continuously in the background while other software applications are being run. The three connectivity tests being performed in the preferred embodiment of the invention are the home network connectivity test presented in FIG. 5A, the Internet Service Provider connectivity presented in FIG. 5B and the connectivity of the Internet Gateway in FIG. 5C.

The software process presented in FIG. 5A begins at state 200 where the STB 300 issues a ping to the connection to the Home Network 26. If the connectivity is acceptable then the software process remains in state 200. A timing loop could also be added so that the network connectivity is only checked on a periodic basis.

If a Home Network ping discovers a Home Network connectivity failure, then the process moves to state 202 and a warning is issued to the User. In response, the User will either be able to close the current window which would return the process to state 200 or to request trouble-shooting data which moves the process to state 204. At state 204, trouble-shooting data is obtained from the system memory of the STB 300 and is displayed to the User. It is possible that the amount of trouble-shooting data will exceed the capacity of one display screen, therefore, there will be an optional tab on the screen so that the User can request more information. Once either the problem is corrected or all of the trouble-shooting data has been exhausted, the process returns to state 200.

In the preferred embodiment the process will wait 300 milliseconds for a response to the ping issued at state 200, before it will decide that the communication attempt has failed.

The software process presented in FIG. 5B begins at state 220 where the STB 300 issues a ping to the connection to the local ISP 308. If the connectivity is acceptable then the software process remains in state 220. A timing loop could also be added so that the ISP connectivity is checked on a periodic basis. If an ISP ping discovers an ISP connectivity failure then the process changes to state 222 and a warning is issued to the User. In response, the User will either be able to close the window which would return the process to state 220 or to request trouble-shooting data which moves the process to state 224.

At state 224, trouble-shooting data is obtained from the system memory of the STB 300 and is displayed to the User. It is possible that the amount of troubleshooting data will exceed the capacity of one display screen, therefore, there will be an optional tab on the screen so that the User can request more information. Once either the problem is corrected or all of the trouble-shooting data has been exhausted, the process returns to state 220.

The ISP connectivity testing at state 220 of FIG. 5B will generally be affected by issuing a number of pings.

Internet Service Providers typically have a number of access channels, for example, having different channels for email and Web Browsing. Thus, pings should be issued to each address. Similarly, a DNS ping should also be issued as part of the connectivity testing at state 220. In each case, the system will allow 300 milliseconds for a response, before deciding that the communication attempt has failed.

A DNS (Domain Name System) server is a server that maintains a database of domain names (host names) and their corresponding IP addresses. The Internet uses IP addresses to identify locations, but these numeric addresses are not as easily remembered as alphanumeric domain names. Hence, a Web browser can be given a domain name such as www.mycompany.com, and it will be sent to a DNS server to be converted to the IP address 204.0.8.51.

Similarly, the software process presented in FIG. 5C begins at state 240 where the STB 300 issues a ping to the Internet Gateway 304. If the connectivity is acceptable, then the software process remains in state 240. A timing loop could also be added so that the Internet Gateway connectivity is checked on a periodic basis. If an Internet Gateway ping discovers a connectivity failure then the process changes to state 242 and a warning is issued to the User. In response, the User will either be able to close the display window, which would return the process to state 240 or to request trouble-shooting data which moves the process to state 244. At state 244, trouble-shooting data is obtained from the system memory of the set-top box 100 and is displayed to the User.

If the amount of trouble-shooting data exceeds the capacity of one display screen, there will be an optional tab on the screen so that the User can request more information. Once either the problem is corrected or all of the trouble-shooting data has been exhausted, the process returns to state 240.

FIGS. 6A through 6D present screen dumps of dialogue boxes that may be used to advise the User of connectivity failures, and further advise the User of the trouble-shooting efforts that should be made before connecting an on-line or telephone Help Desk or Service Representative.

This troubleshooting checklist helps reduce the number of calls that have to be made to the Help Desk, thus reducing overall costs of the system. As well, the calls that are made, are directed to the proper Help Desk by the invention. Without any diagnostics, most User help calls would be directed to the STB Service Provider's main help number, rather than to the party that caused the problem (for example, a particular software, hardware or content provider).

The invention also increases User satisfaction, as Users are able to correct problems much more quickly than having to contact a generic Help Desk.

In the event of an Internet Connection failure at state 220 of FIG. 5B, for example, the User will be presented with the dialogue box of FIG. 6A. If the connection check was unsuccessful due to an Internet connection problem, then the User would see this screen.

Note that the content of the dialogue box can vary with the context of the error. That is, the connectivity test may be operable to detect where or how the error took place. As noted above, for example, several pings are issued to the ISP, thus, the software of the invention may be tailored to the particular ISP ping which failed.

For each dialogue box, there should be a separate numeric or alpha-numeric identifier, which would assist the HelpDesk if they had to be contacted. In addition to including this Internet Connection Error #, exemplary content for this dialogue box could include the following:

1. The Network could be slow right now. Please check for Web access from your computer.

2. Make sure your Gateway is connected to the modem.

3. Check that your modem is turned on and working.

4. Call your ISP to see if they are having problems.

5. Check that your set top box yellow light is on.

The dialogue box will also include command tabs for the following:

1. a “More Info” button which links this window to another window with additional trouble-shooting information. Once all of the trouble-shooting windows have been exhausted, control will pass to a generic Help window such as the one presented in FIG. 6D;

2. a “Try Again” button to re-test the connection; and

3. a “Close” button to ignore the problem and close the dialog box.

Similarly, in the event of a Home Network Connection failure at state 200 of FIG. 5A, the User will be presented with the dialogue box of FIG. 6B. Again, the connectivity test could include diagnostics that vary the content of the dialogue box depend on the nature of the error. As well, this dialogue box also includes a separate numeric or alpha-numeric identifier, to assist the HelpDesk or to allow the User to obtain further information in an electronic or hard-copy paper User's manual.

In addition the Home Network Connection Error #, exemplary content for this dialogue box could include the following:

1. Check the wiring between the ESTB and Gateway.

2. Make sure the power is on the Gateway.

3. If there is a link light on the Gateway verify that it is illuminated.

4. If there is a link light on the ESTB, verify that it is illuminated.

5. Make sure you are using one of the following gateways . . .

6. If you are using a custom network configuration, please check your settings by . . .

Like the Internet Connectivity Error dialogue box, this dialogue box should also include buttons for “More Info”, “Try Again” and “Close”.

The third trouble-shooting dialogue box in the preferred embodiment of the invention is intended to address a physical connection failure at the STB 300 level. Like the trouble-shooting dialogue boxes listed above, this dialogue box includes a Set-Top Box Connection Error #, and trouble-shooting suggestions. These suggestions might include the following, or other suggestions appropriate to the platform and particulars:

1. Make sure the dongle is properly connected to the STB.

2. Check for a LINK light on the dongle.

3. Check to make sure the Gateway is properly connected and powered on.

4. Try restarting the STB before calling.

Again, this dialogue box should also have buttons for “More Info”, “Try Again” and “Close”.

As noted, when all troubleshooting screens are exhausted, the software of the invention simply begins to display generic help dialogue boxes such as the one in FIG. 6D. As for all of the dialogue boxes herein, the content and topics will change according to customer, marketing, and operational needs. Typically though, entries would include:

1. General IOTV information

2. DSL Modem

3. Home Network/Getway

4. Wired Connection to the STB

5. Wireless Connection to the STB

6. USB Port to the STB

7. STB Hardware

8. Internet, email, Instant Messaging and Chat Applications

In this case, each help screen may be content-heavy and allow Users to navigate to a deeper details page, return to the Help Index page, or cancel and return to watching full screen television programming. However, it is recommended that the amount of Help text be limited per topic for this medium, since the television 22 is not a good medium for reading. If more Help information is needed, it should be enclosed in a physical manual or should point the customer towards a Web site.

Options and Alternatives

The invention is not limited by the nature of the content, software applications and physical components described herein. As well, it is clear that many alternative embodiments could also be employed. For example:

1. the connectivity tests can be made in response to certain requests. For example, when the User makes a request to toggle from one application to another, a ping could be made for the new service. This would test the new service before the User commits to the toggling;

2. the connectivity tests can be made along with other requests. For example, a ping could be made when the User submits his login and password to access a certain service; or

3. diagnostic tests could also be run on a continuous basis for many other system services and physical components, such as for the High Bandwidth Service.

The “contextual help” concept of the invention can also be used in applications other than troubleshooting, for example, in registering Users to new services. For example, the STB 20 may detect that the User has attempted to access a service which is not consistent with his subscription. In addition to advising the User of the error, the STB 20 could also provide instruction screens that assist the User in subscribing to the new service.

The task of signing Users up to new services had been done manually in the past. Similar to the case of the troubleshooting embodiment, the invention would allow the number of support persons to be reduced. This reduces overhead costs, saving the service provider money.

Many variations to the architecture are also possible. As note above, for example, the Internet modem may be internal to the set-top box as shown in FIG. 2, or external as in FIG. 4. Another alternative to the architecture shown in FIG. 4 is to use a dual port modem in lieu of the DSL modem 306. This would eliminate the need for a separate Home Networking/Internet Gateway device.

### CONCLUSIONS

While particular embodiments of the present invention have been shown and described, it is clear that changes and modifications may be made to such embodiments without departing from the true scope and spirit of the invention.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, smart appliances, Bluetooth devices, personal digital assistants and Internet-ready telephones. Again, such implementations would be clear to one skilled in the art, and do not take away from the invention.

What is claimed is:

1. A convergent multimedia system comprising:
an Internet Service Provider (ISP) connected to an Internet network;
a Home Network;
a convergent multimedia device on said Home Network;
an Internet Gateway connected to said Home Network; and
a hard-wired, communication network for connecting said Internet Gateway to said ISP;
said convergent multimedia device having a multitasking operating system, being connected to a display screen and an audio output device, and being operable to perform the steps of:
checking connectivity between said convergent multimedia device and said Internet Gateway;
checking connectivity between said convergent multimedia device and an address on said Internet network;
checking connectivity between said convergent multimedia device and said Home Network; and
responding to the failure of one or more of said connections by presenting an announcement on said display screen or said audio output device.

2. The system of claim 1, wherein said step of checking connectivity between said convergent multimedia device and an address on said Internet network comprises issuing a “ping”.

3. The system of claim 1, wherein said step of checking connectivity between said convergent multimedia device and an address on said Internet network comprises issuing a “gethost”.

4. The system of claim 1, wherein said step of checking connectivity between said convergent multimedia device and an address on said Internet network comprises the step of checking connectivity between said convergent multimedia device and a DNS (domain name server) on said Internet network.

5. The system of claim 1, wherein said step of checking connectivity between said convergent multimedia device and an address on said Internet network comprises the step of checking connectivity between said convergent multimedia device and said ISP.

6. The system of claim 1, wherein said steps of checking are performed periodically.

7. The system of claim 1, wherein said wireless transmitter comprises an Earth-orbiting satellite.

8. The system of claim 3, wherein said Earth-orbiting satellite comprises a geo-stationary satellite.

9. The system of claim 1, wherein said Home Network comprises a home or small office/home office network.

10. The system of claim 1, wherein said Home Network comprises an Ethernet network.

11. The system of claim 1, wherein said hard-wired, communication network comprises a digital subscriber line (DSL) communication network.

12. The system of claim 1, wherein said hard-wired, communication network comprises cable modems and a television cable network.

13. The system of claim 1, wherein said convergent multimedia device is further operable to perform the steps of:
responding to the failure of one or more of said connections by presenting help data on said display screen of said convergent multimedia device.

14. The system of claim 1, wherein said convergent multimedia device is further operable to perform the steps of:
responding to the failure of one or more of said connections by presenting troubleshooting information on said display screen of said convergent multimedia device.

15. The system of claim 1, wherein said convergent multimedia device is a set-top box (STB) and said display screen is incorporated in a computer.

16. The system of claim 1, wherein said convergent multimedia device is a television set-top box (STB) and said display screen is incorporated in a television.

17. The system of claim 1, wherein said multitasking operating system comprises a public-domain operating system and a windows manager.

18. The system of claim 17, wherein said multitasking operating system comprises a Linux operating system and a windows manager.

19. A method of operating a convergent multimedia device comprising the steps of:
checking connectivity between said convergent multimedia device and an Internet Gateway;
checking connectivity between said convergent multimedia device and an Internet Service Provider;
checking connectivity between said convergent multimedia device and a Home Network; and
responding to the failure of one or more of said connections by presenting an announcement on a display screen or an audio output device.

20. A method of operating a convergent multimedia device comprising the steps of:
performing connectivity testing between said convergent multimedia device and interconnected devices; and
responding to the failure of one or more of said connections by presenting an announcement on a display screen.

21. A method of operating a convergent multimedia device having an antenna for receiving transmissions from a wireless transmitter, a multitasking operating system, being connected to a display screen, an audio output device and a Home Network, said Home Network being connected to an Internet Service Provider via a hard-wired, communication network, and said method comprising the steps of:
checking connectivity between said convergent multimedia device and said wireless transmitter;
checking connectivity between said convergent multimedia device and said Internet Service Provider;
checking connectivity between said convergent multimedia device and said Home Network; and
responding to the failure of one or more of said connections by presenting an alarm on said display screen or said audio output device.

22. A convergent multimedia system comprising:
a high-bandwidth network;
an Internet Service Provider;
a Home Network;
a convergent multimedia device on said Home Network, having a receiver for receiving transmissions from said high-bandwidth network; and
a hard-wired, communication network for connecting said Home Network to said Internet Service Provider;
said convergent multimedia device having a multitasking operating system, being connected to a display screen and an audio output device, and being operable to perform the steps of:
checking connectivity between said convergent multimedia device and said high-bandwidth network;
checking connectivity between said convergent multimedia device and said an Internet Service Provider;
checking connectivity between said convergent multimedia device and said a Home Network; and
responding to the failure of one or more of said connections by presenting an alarm on said display screen or said audio output device.

23. A convergent multimedia system comprising:
a wireless transmitter;
an Internet Service Provider;
a Home Network;
a convergent multimedia device on said Home Network, and having an antenna for receiving transmissions from said wireless transmitter; and
a hard-wired, communication network for connecting said Home Network to said Internet Service Provider;
said convergent multimedia device having a multitasking operating system, being connected to a display screen and an audio output device, and being operable to perform the steps of:
checking connectivity between said convergent multimedia device and said wireless transmitter;
checking connectivity between said convergent multimedia device and said an Internet Service Provider;
checking connectivity between said convergent multimedia device and said a Home Network; and
responding to the failure of one or more of said connections by presenting an alarm on said display screen or said audio output device.
